(19) United States
(12) Patent Application Publication
(10) Pub. No.: US 2026/0117099 A1
(43) Pub. Date: Apr. 30, 2026

(54) ADHESIVE FILM AND OPTICAL DISPLAY APPARATUS COMPRISING THE SAME

(71) Applicant: SAMSUNG SDI CO., LTD., Yongin-si (KR)

(72) Inventors: Jin Young LEE, Suwon-si (KR); Se Mi HEO, Suwon-si (KR); Il Jin KIM, Suwon-si (KR); Tae Mi KIM, Suwon-si (KR); Dong Myeong SHIN, Suwon-si (KR); Jun Ki OH, Suwon-si (KR); Gwang Hwan LEE, Suwon-si (KR); Ji Young HAN, Suwon-si (KR)

(21) Appl. No.: 19/342,249

(22) Filed: Sep. 26, 2025

(30) Foreign Application Priority Data
Oct. 28, 2024 (KR) 10-2024-0148510

(51) Int. Cl. C09J 7/38; C09J 11/06

(52) U.S. Cl. CPC C09J 7/385; C09J 11/06; C09J 2203/326; C09J 2301/21; C09J 2301/414; C09J 2301/416

(57) ABSTRACT

An adhesive film and an optical display apparatus including the adhesive film are provided. The adhesive film includes a first region and a second region having different storage moduli, wherein the first region and the second region satisfy Relation 1 and Relation 2:

$$0.01 \leq {G}^{′} ( {25}^{∘} C . / B ) / {G}^{′} ( {25}^{∘} C . / A ) \leq 0 \text{.2} , \qquad ( Relation 1 )$$

$$0.1 \leq {G}^{′} ( {60}^{∘} C . / B ) / {G}^{′} ( {60}^{∘} C . / A ) \leq 0 \text{.5} , \qquad ( Relation 2 )$$

where G′(25° C./A) denotes a storage modulus of the first region at 25° C. and G′(25° C./B) denotes a storage modulus of the second region at 25° C., and
G′(60° C./A) denotes a storage modulus of the first region at 60° C. and G′(60° C./B) denotes a storage modulus of the second region at 60° C.

### CROSS-REFERENCE TO RELATED APPLICATION

The present application claims priority to and the benefit of Korean Patent Application No. 10-2024-0148510, filed on Oct. 28, 2024, in the Korean Intellectual Property Office, the entire disclosure of which is incorporated herein by reference.

### BACKGROUND

### 1. Field

One or more embodiments of the present invention relate to an adhesive film and an optical display apparatus including the same.

### 2. Description of the Related Art

An optical display apparatus may include display elements including a window film, a touch pad, a conductive film, an organic light emitting device, and the like. The touchpad may have a structure in which a transparent adhesive layer (OCA, optically clear adhesive) is interposed between the window film and the conductive film. The transparent adhesive layer may also be interposed between two among the window film, the conductive film, a polarizer, and the organic light emitting device. Recently, flexible displays have been developed and drawn significant attention as an optical display apparatus.

Flexible displays require flexibility of various optical elements therein. Because the transparent adhesive layer is formed between the window film and the conductive film, the transparent adhesive layer must have good adhesion on both sides thereof. In addition, the transparent adhesive layer must have good flexibility and foldability. For example, the flexible display may include a bendable region where bending occurs and a non-bendable region that does not require bending. In general, the bendable region may refer to a region of the flexible display where a user folds the flexible display. The non-bendable region is located around and/or along the bendable region and may refer to, for example, a region of the flexible display where the user holds the flexible display. The bendable region requires good flexibility and foldability. In the non-bendable region, the transparent adhesive layer should not be compressed, and an organic light emitting device panel should not be damaged and/or deformed.

### SUMMARY

One or more aspects of embodiments of the present disclosure are directed toward an adhesive film having good rollability and impact resistance. Additional aspects will be set forth in part in the description which follows and, in part, will be apparent from the description, or may be learned by practice of the presented embodiments of the disclosure.

According to one or more embodiments of the present disclosure, there is provided an adhesive film.

The adhesive film includes a first region and a second region having different storage moduli, wherein the first region and the second region satisfy Relation 1 and Relation 2:

$$0.01 \leq {G}^{′} ( {25}^{∘} C . / B ) / {G}^{′} ( {25}^{∘} C . / A ) \leq 0 \text{.2} , \qquad ( Relation 1 )$$

where G′(25° C./A) denotes a storage modulus of the first region at 25° C. and G′(25° C./B) denotes a storage modulus of the second region at 25° C.; and

$$0.1 \leq {G}^{′} ( {60}^{∘} C . / B ) / {G}^{′} ( {60}^{∘} C . / A ) \leq 0 \text{.5} , \qquad ( Relation 2 )$$

where G′(60° C./A) denotes a storage modulus of the first region at 60° C. and G′(60° C./B) denotes a storage modulus of the second region at 60° C.

According to one or more embodiments of the present disclosure, there is provided an optical display apparatus.

The optical display apparatus includes the adhesive film.

Accordingly, embodiments of the present disclosure provide an adhesive film that exhibits good properties in terms of both rollability and impact resistance.

### BRIEF DESCRIPTION OF DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and benefits of the present disclosure will become more apparent to those of ordinary skill in the art from the following exemplary embodiments thereof described in detail with reference to the accompanying drawings.

FIG. 1 is a cross-sectional view of an adhesive film according to one or more embodiments of the present disclosure.

FIG. 2 is a diagram of a state of an adhesive film according to one or more embodiments of the present disclosure: (a) is a diagram of a post-rollable state of the adhesive; (b) is a diagram of a pre-rollable state of the adhesive film.

FIG. 3 is an evaluation schematic of rollable reliability according to one or more embodiments of the present disclosure.

### DETAILED DESCRIPTION

Hereinafter, example embodiments of the present disclosure will be described in detail with reference to the accompanying drawings such that the present disclosure may be easily implemented and understood by a person having ordinary knowledge in the art. It should be understood that the present disclosure may be embodied in various ways and is not limited to the following embodiments. In the drawings, portions irrelevant to or not essential to the description will not be provided for clarity, and like components will be denoted by like reference numerals throughout the disclosure.

Herein, spatially relative terms such as “upper” and “lower” are defined with reference to the accompanying drawings. Thus, it will be understood that the term “upper surface” may be used interchangeably with the term “lower surface”. When an element such as a layer or film is referred to as being placed “on” another element, it may be directly placed on the other element, or one or more intervening element(s) may be present therebetween. In contrast, when an element is referred to as being placed “directly on” another element, there are no intervening element(s) therebetween.

Herein, “(meth)acryl” refers to acryl and/or methacryl.

Herein, “copolymer” may include an oligomer, a polymer, or a resin.

One or more embodiments of the present disclosure provide an adhesive film having good rollability and impact resistance. The adhesive film includes a first region and a second region which will be described below, wherein the first region and the second region are integrally (e.g., laterally integrally) formed with each other to form a single layer and have good rollability and impact resistance. Accordingly, the adhesive film may be used in a rollable display apparatus.

Hereinafter, an adhesive film according to one or more embodiments of the present disclosure will be described in more detail.

The adhesive film includes regions with different storage moduli in a single plane. For example, the adhesive film includes a first region and a second region, wherein the first region and the second region have different storage moduli at a same measurement temperature.

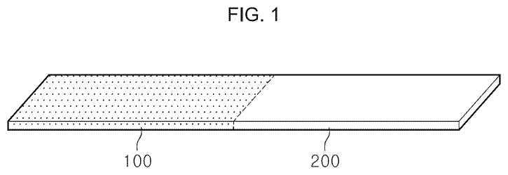

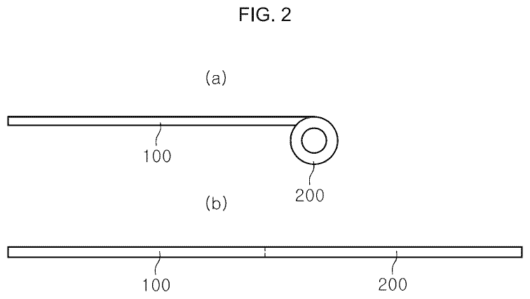

FIG. 1 is a conceptual view of an adhesive film according to one or more embodiments of the present disclosure. FIG. 2 is a diagram of a state of an adhesive film according to one or more embodiments of the present disclosure, wherein (a) of FIG. 2 is diagram of a post-rollable state of the adhesive film, and (b) of FIG. 2 is a diagram of a pre-rollable state of the adhesive film. Referring to FIG. 1 and FIG. 2, the adhesive film includes a first region 100 and a second region 200, wherein the first region 100 and the second region 200 are integrally (e.g., laterally integrally) formed with each other.

Referring to FIG. 1, in one or more embodiments, the adhesive film consists of two regions in total in the order of the first region 100 and the second region 200 on an outermost surface of the adhesive film in a longitudinal direction thereof, wherein one of outermost surfaces of the adhesive film in a transverse direction constitutes the first region 100 and the other outermost surface of the adhesive film in the transverse direction constitutes the second region 200.

The first region and the second region satisfy Relation 1 and Relation 2:

$$0.01 \leq {G}^{′} ( {25}^{∘} C . / B ) / {G}^{′} ( {25}^{∘} C . / A ) \leq 0 \text{.2} , \qquad ( Relation 1 )$$

where G′(25° C./A) denotes a storage modulus of the first region at 25° C. and G′(25° C./B) denotes a storage modulus of the second region at 25° C.; and

$$0.1 \leq {G}^{′} ( {60}^{∘} C . / B ) / {G}^{′} ( {60}^{∘} C . / A ) \leq 0 \text{.5} , \qquad ( Relation 2 )$$

where G′(60° C./A) denotes a storage modulus of the first region at 60° C. and G′(60° C./B) denotes a storage modulus of the second region at 60° C.

Relations 1 and 2 are criteria for determining whether impact resistance in the first region and rollability by the second region can be realized simultaneously. The first region may correspond to a non-rollable region when the adhesive film is applied to a display apparatus. The second region may correspond to a rollable region. Although the first region does not have a rollable function, it is desirable that the first region has good impact resistance. On the other hand, it is desirable that the second region has high rollability. If (e.g., when) the second region is formed only on one side of the first region to become rollable, the first region is bound to be affected by the second region. With the relationship between the first region and the second region as shown in Relation 1 and Relation 2, the adhesive film may realize the impact resistance of the first region and the rollable function of the second region in a balanced manner.

In one or more embodiments, G′(25° C./B)/G′(25° C./A) may be in the range of, for example, about 0.01 to about 0.2, about 0.05 to about 0.2, about 0.1 to about 0.2, or about 0.15 to about 0.2. In one or more embodiments, G′(25° C./B)/G′(25° C./A) may be about 0.05, about 0.1, about 0.15, or about 0.2.

In one or more embodiments, G′(60° C./B)/G′(60° C./A) may be in the range of, for example, about 0.1 to about 0.5, about 0.1 to about 0.4, about 0.1 to about 0.3, about 0.1 to about 0.2, about 0.2 to about 0.5, about 0.3 to about 0.5, about 0.4 to about 0.5, or 0.3 to 0.4. In one or more embodiments, G′(60° C./B)/G′(60° C./A) may be, for example, about 0.1, about 0.15, about 0.2, about 0.25, about 0.3, about 0.35, about 0.4, about 0.45, or about 0.5.

The adhesive film may have a thickness of about 5 μm to about 50 μm, for example, about 5 μm to about 30 μm.

According to one or more embodiments, the first region and the second region may each be a pressure sensitive adhesive film (PSA).

The first region and the second region will now be described in more detail.

### First Region

The first region may be located on a non-rollable portion when the adhesive film is applied to an optical display apparatus. The first region may have good impact resistance to protect optical elements when the adhesive film is applied to the optical display apparatus.

The first region may have a storage modulus of about 0.01 MPa to about 10 MPa at 25° C., for example, about 0.05 MPa, about 0.1 MPa, about 0.15 MPa, about 0.2 MPa, about 0.25 MPa, about 0.3 MPa, about 0.35 MPa, about 0.4 MPa, about 0.45 MPa, about 0.5 MPa, about 0.55 MPa, about 0.6 MPa, about 0.65 MPa, about 0.7 MPa, about 0.75 MPa, about 0.8 MPa, about 0.85 MPa, about 0.9 MPa, about 0.95 MPa, about 1 MPa, or about 0.05 MPa to about 1 MPa, or about 0.1 MPa to about 0.8 MPa. Within this range, Relation 1 may be easily achieved.

The first region may have a storage modulus of about 0.005 MPa to about 1 MPa at 60° C., for example, about 0.005 MPa, about 0.01 MPa, about 0.02 MPa, about 0.03 MPa, about 0.04 MPa, about 0.05 MPa, about 0.06 MPa, about 0.07 MPa, about 0.08 MPa, about 0.09 MPa, about 0.1 MPa, about 0.11 MPa, about 0.12 MPa, about 0.13 MPa, about 0.14 MPa, about 0.15 MPa, about 0.16 MPa, about 0.17 MPa, about 0.18 MPa, about 0.19 MPa, about 0.2 MPa, or about 0.01 MPa to about 0.2 MPa, or about 0.05 MPa to about 0.1 MPa. Within this range, Relation 2 may be readily achieved.

The first region may have a creep of about 10% or more, for example, about 10% to about 50%, or about 10% to about 40%, as measured at 60° C. Within this range, the adhesive film may have good peel strength and reliability.

The first region may include a photo-cured product of a composition for the first region including: a monomer mixture; and an initiator. In one or more embodiments, the composition for the first region may further include a crosslinking agent. In one or more embodiments, the composition for the first region may further include one or more additives.

In one or more embodiments, the composition for the first region may include a monomer mixture for a hydroxyl group-containing (meth)acrylic copolymer and an initiator. The monomer mixture may be present in the composition for the first region as a monomer mixture that is not polymerized at all, or as a partially polymerized polymer.

The monomer mixture may form a hydroxyl group-containing (meth)acrylic copolymer. The hydroxyl group-containing (meth)acrylic copolymer may form a matrix of the first region and may exhibit adhesive properties. The hydroxyl group-containing (meth)acrylic copolymer may have a glass transition temperature of about −100° C. to about 10° C., for example, about −70° C. to about 0° C. Within this range, the adhesive film has good adhesion and reliability in a wide temperature range. The hydroxyl group-containing (meth)acrylic copolymer may have an index of refraction of about 1.35 to about 1.70, for example, about 1.40 to about 1.60. Within this range, the adhesive film may maintain transparency when stacked together with other optical films.

The monomer mixture may include an alkyl group-containing (meth)acrylate and an alicyclic group-containing (meth)acrylate. The monomer mixture may further include a hydroxyl group-containing (meth)acrylate and a heterocyclic group-containing vinyl or (meth)acrylic monomer.

In one or more embodiments, the alkyl group-containing (meth)acrylate, the alicyclic group-containing (meth)acrylate, the hydroxyl group-containing (meth)acrylate, and the heterocyclic group-containing vinyl or (meth)acrylic monomer may be present in a total amount of about 95 wt % or more, for example, about 95 wt % to 100 wt %, or 100 wt %, in the monomer mixture, based on a total weight of 100 wt % of the monomer mixture.

The alkyl group-containing (meth)acrylate may include a monofunctional (meth)acrylic acid ester having an unsubstituted C₁ to C₂₀ linear or branched alkyl group.

The alkyl group-containing (meth)acrylate may include, for example, 2-ethylhexyl (meth)acrylate, n-butyl (meth)acrylate, iso-octyl (meth)acrylate, propyl (meth)acrylate, t-butyl (meth)acrylate, iso-butyl (meth)acrylate, pentyl (meth)acrylate, hexyl (meth)acrylate, heptyl (meth)acrylate, octyl (meth)acrylate, nonyl (meth)acrylate, and decyl (meth)acrylate. In one or more embodiments, the alkyl group-containing (meth)acrylate may include at least one selected from among 2-ethylhexyl (meth)acrylate, n-butyl (meth)acrylate, and isooctyl (meth)acrylate. In one or more embodiments, the alkyl group-containing (meth)acrylate may include 2-ethylhexyl (meth)acrylate.

The alkyl group-containing (meth)acrylate may be present in an amount of about 10 wt % to about 80 wt %, for example, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, or about 30 wt % to about 80 wt %, or about 30 wt % to about 50 wt %, in the monomer mixture, based on the total weight of the monomer mixture. Within this range, the adhesive film may achieve further improvement in adhesion and durability.

The alicyclic group-containing (meth)acrylate may include a (meth)acrylic acid ester having a substituted or unsubstituted C₅ to C₁₅ alicyclic group at an ester site thereof. In one or more embodiments, the alicyclic group-containing (meth)acrylate may include an isobornyl (meth)acrylate.

The alicyclic group-containing (meth)acrylate may be present in an amount of about 10 wt % to about 60 wt %, for example, about 10 wt %, about 15 wt %, about 20 wt %, about 25 wt %, about 30 wt %, about 35 wt %, about 40 wt %, about 45 wt %, about 50 wt %, about 55 wt %, about 60 wt %, or about 30 wt % to about 40 wt %, in the monomer mixture, based on the total weight of the monomer mixture. Within this range, the adhesive film may achieve further improvement in adhesion and durability.

The hydroxyl group-containing (meth)acrylate may impart adhesion to the adhesive film. The hydroxyl group-containing (meth)acrylate may have a homopolymer glass transition temperature of about 0° C. to about −40° C., for example, about −10° C. to about −40° C., or about −20° C. to about −40° C. Within this range, the hydroxyl group-containing (meth)acrylate may improve adhesion and flexural reliability of the adhesive film.

The hydroxyl-containing (meth)acrylate may be a monofunctional (meth)acrylic acid ester having a C₁ to C₂₀ linear or branched alkyl group containing at least one hydroxyl group. For example, the hydroxyl-containing (meth)acrylate may include at least one selected from among 2-hydroxybutyl (meth)acrylate, 4-hydroxybutyl (meth)acrylate, 2-hydroxyethyl (meth)acrylate, 2-hydroxypropyl (meth)acrylate, 3-hydroxypropyl (meth)acrylate, and 6-hydroxyhexyl (meth)acrylate.

The hydroxyl-containing (meth)acrylate may be present in an amount of 0 wt % to about 40 wt %, for example, 0 wt %, about 5 wt %, about 10 wt %, about 15 wt %, about 20 wt %, about 25 wt %, about 30 wt %, about 35 wt %, about 40 wt %, or about 5 wt % to about 40 wt %, about 10 wt % to about 40 wt %, about 10 wt % to about 30 wt %, or about 10 wt % to about 20 wt %, in the monomer mixture, based on the total weight of the monomer mixture. Within this range, the adhesive film may achieve further improvement in adhesion and durability.

The heterocyclic group-containing vinyl or (meth)acrylic monomer may be a vinyl or (meth)acrylic monomer having a C₃ to C₁₀ heterocyclic group having at least one of oxygen, sulfur, or nitrogen as an element constituting the ring. The heterocyclic group-containing vinyl or (meth)acrylic monomer may include at least one selected from among (meth)acryloylmorpholine and vinylpyrrolidone.

The heterocyclic group-containing vinyl or (meth)acrylic monomer may be present in an amount of 0 wt % to about 30 wt %, for example, 0 wt %, about 5 wt %, about 10 wt %, about 15 wt %, about 20 wt %, about 25 wt %, about 30 wt %, or about 1 wt % to about 30 wt %, about 5 wt % to about 30 wt %, or about 5 wt % to about 10 wt %, in the monomer mixture, based on the total weight of the monomer mixture. Within this range, the adhesive film may achieve further improvement in adhesion and durability.

In one or more embodiments, the monomer mixture may further include a copolymerizable monomer in addition to the monomers mentioned above. The copolymerizable monomer may include at least one selected from among an amine group-containing monomer, an alkylene glycol group-containing monomer, a silane group-containing monomer, and an aromatic group-containing monomer.

The initiator may be used to cure (e.g., partially polymerize) the monomer mixture into a (meth)acrylic copolymer, or to cure a viscous liquid into a film. The initiator may include a photopolymerization initiator and/or a heat polymerization initiator.

The photopolymerization initiator may be selected from any typical initiators so long as the initiator may induce polymerization reaction of a radical polymerizable compound described above during a curing process by irradiation with light and/or the like. For example, the photopolymerization initiator may include a benzoin photoinitiator, a hydroxy ketone photoinitiator, an aminoketone photoinitiator, or a phosphine oxide photoinitiator. For example, the photopolymerization initiator may include benzoin, benzoin methyl ether, benzoin ethyl ether, benzoin isopropyl ether, benzoin n-butyl ether, benzoin isobutyl ether, an acetophenone compound, such as 2,2-dimethoxy-2-phenylacetophenone, 2,2′-diethoxyacetophenone, 2,2′-dibutoxyacetophenone, 2-hydroxy-2-methylpropiophenone, p-t-butyl trichloroacetophenone, p-t-butyl dichloroacetophenone, 4-chloroacetophenone, 2,2′-dichloro-4-phenoxyacetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, and the like, 2-benzyl-2-dimethylamino-1-(4-morpholinophenyl)-butan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenyl benzophenone, 4,4-diethylaminobenzophenone, dichlorobenzophenone, 2-methylanthraquinone, 2-ethylanthraquinone, 2-t-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, a p-dimethylamino benzoic acid ester, oligo [2-hydroxy-2-methyl-1-[4-(1-methylvinyl)phenyl]propanone], 2,4,6-trimethylbenzoyl-diphenyl-phosphine oxide, and the like, without being limited thereto. These may be used alone or as a mixture thereof.

The heat polymerization initiator may be selected from any typical initiators, for example, azo compounds, peroxide compounds, or redox compounds, so long as the initiator has the aforementioned properties. Examples of the azo compounds may include 2,2-azobis(2-methylbutyronitrile), 2,2-triazobis(isobutyronitrile), 2,2-triazobis(2,4-dimethylvaleronitrile), 2,2-nitroazobis-2-hydroxymethylpropionitrile, dimethyl-2,2-methylazobis(2-methylpropionate), 2,2-azobis(4-methoxy-2,4-dimethylvaleronitrile), and the like; examples of the peroxide compounds may include inorganic peroxides such as potassium persulfate, ammonium persulfate, and hydrogen peroxide, and organic peroxides, such as diacyl peroxide, peroxy dicarbonate, peroxy esters, tetramethylbutylperoxyneodecanoate, bis(4-butylcyclohexyl) peroxydicarbonate, di(2-ethylhexyl) peroxy carbonate, butylperoxyneodecanoate, dipropyl peroxydicarbonate, diisopropyl peroxydicarbonate, diethoxyethyl peroxydicarbonate, diethoxyhexyl peroxy dicarbonate, hexyl peroxy dicarbonate, dimethoxybutyl peroxy dicarbonate, bis(3-methoxy-3-methoxybutyl) peroxy dicarbonate, dibutyl peroxy dicarbonate, dicetyl peroxy dicarbonate, dimyristyl peroxy dicarbonate, 1,1,3,3-tetramethylbutyl peroxypivalate, hexyl peroxypivalate, butyl peroxypivalate, trimethyl hexanoyl peroxide, dimethyl hydroxybutyl peroxyneodecanoate, amyl peroxyneodecanoate, butyl peroxyneodecanoate, t-butyl peroxyneodecanoate, t-butyl peroxy neoheptanoate, amyl peroxypivalate (pivalate), t-butyl peroxypivalate, t-amyl peroxy-2-ethylhexanoate, lauryl peroxide, dilauroyl peroxide, didecanoyl peroxide, benzoyl peroxide, dibenzoyl peroxide, and the like; and examples of the redox compounds may include mixtures of peroxide compounds and reducing agents, and the like, without being limited thereto. These azo compounds, peroxide compounds, or redox compounds may be used alone or as a mixture thereof.

The initiator may be present in an amount of about 0.0001 parts by weight to about 5 parts by weight, for example, 0.001 parts by weight to about 3 parts by weight, for example, about 0.001 parts by weight to about 1 part by weight, relative to 100 parts by weight of the monomer mixture. Within this range, the initiator may secure complete curing of the composition without deterioration in light transmittance of the adhesive film due to remaining initiator, and may exhibit good reactivity while suppressing generation of bubbles.

In one or more embodiments, the composition for the first region may further include at least one selected from among a crosslinking agent and additives.

The crosslinking agent may include at least one type of (meth)acrylate selected from among bi- or higher functional (meth)acrylates (e.g., (meth)acrylate having two or more functional groups), for example, bi- to hexa-functional (meth)acrylates. For example, the crosslinking agent may include one or more selected from among bifunctional (meth)acrylates, such as 1,4-butanediol di(meth)acrylate, 1,6-hexanediol di(meth)acrylate, neopentylglycol di(meth)acrylate, polyethylene glycol di(meth)acrylate, neopentylglycol adipate di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclododecanedimethanol (meth)acrylate, dimethylol dicyclopentane di(meth)acrylate, ethylene oxide modified hexahydrophthalic acid di(meth)acrylate, tricyclodecane dimethanol (meth)acrylate, neopentylglycol-modified trimethylpropane di(meth)acrylate, adamantane di(meth)acrylate, 9,9-bis [4-(2-acryloyloxyethoxy)phenyl]fluorene, and the like; trifunctional (meth)acrylates, such as trimethylolpropane tris(meth)acrylate, dipentaerythritol tris(meth)acrylate, propionic acid-modified dipentaerythritol tris(meth)acrylate, pentaerythritol tris(meth)acrylate, propylene oxide-modified trimethylolpropane tris(meth)acrylate, tris(meth)acryloxyethyl isocyanurate, and the like; tetrafunctional (meth)acrylates, such as diglycerin tetra(meth)acrylate, pentaerythritol tetra(meth)acrylate, and the like; pentafunctional (meth)acrylates, such as pentaerythritol penta(meth)acrylate and the like; and hexafunctional (meth)acrylates, such as dipentaerythritol hexa(meth)acrylate, caprolactone-modified dipentaerythritol hexa(meth)acrylate, and the like, without being limited thereto.

The crosslinking agent may be present in an amount of about 0.0001 parts by weight to about 5 parts by weight, for example, about 0.1 parts by weight to about 5 parts by weight, for example, about 0.5 parts by weight to about 1 part by weight, relative to 100 parts by weight of the monomer mixture.

The additive may include a silane coupling agent.

The silane coupling agent may further improve peel strength of the adhesive film. The silane coupling agent may include one or more typical silane coupling agents known to those skilled in the art. For example, the silane coupling agent may include an epoxy group-containing silane coupling agent, such as glycidoxypropyltrimethoxysilane, glycidoxypropylmethyldimethoxysilane, and the like, without being limited thereto.

The silane coupling agent may be present in an amount of about 0.0001 parts by weight to about 5 parts by weight, for example, about 0.1 parts by weight to about 5 parts by weight, for example, about 0.5 parts by weight to about 1 part by weight, relative to 100 parts by weight of the monomer mixture.

In one or more embodiments, the composition for the first region may further include one or more additives other than the silane coupling agent. The additives may include at least one type selected from among UV absorbents, reaction inhibitors, adhesion enhancers, thixotropic imparting agents, conductivity imparting agents, color modifiers, stabilizers, antioxidants, leveling agents, and antistatic agents, without being limited thereto. The content of the additives in the composition, that is, in the first region, may be suitably selected within the range that does not deteriorate the effects of the present disclosure.

### Second Region

The second region may be located on a rollable portion when the adhesive film is applied to an optical display apparatus. The second region may provide a folding effect when the adhesive film is applied to the optical display apparatus.

The second region may have a storage modulus of about 0.001 MPa to about 1 MPa, for example, about 0.001 MPa, about 0.01 MPa, about 0.02 MPa, about 0.03 MPa, about 0.04 MPa, about 0.05 MPa, about 0.06 MPa, about 0.07 MPa, about 0.08 MPa, about 0.09 MPa, about 0.1 MPa, or about 0.005 MPa to about 0.1 MPa, or about 0.01 MPa to about 0.1 MPa, as measured at 25° C. Within this range, Relation 1 may be easily achieved.

The second region may have a storage modulus of about 0.0005 MPa to about 0.1 MPa, for example, about 0.005 MPa to about 0.05 MPa, or about 0.01 MPa to about 0.1 MPa, as measured at 60° C. Within this range, Relation 2 may be easily achieved.

The second region may have a creep of about 10% or more, for example, about 10% to about 50%, as measured at 60° C. Within this range, the adhesive film may have good peel strength and reliability.

The second region may include a photo-cured product of a composition for the second region including: a monomer mixture; and an initiator. In one or more embodiments, the composition for the second region may further include a crosslinking agent. In one or more embodiments, the composition for the second region may further include one or more additives.

The monomer mixture may be present in the composition for the second region as a monomer mixture that is not polymerized at all, or as a partially polymerized polymer.

The monomer mixture may form a hydroxyl group-containing (meth)acrylic copolymer. The hydroxyl group-containing (meth)acrylic copolymer may form a matrix of the second region and may exhibit adhesive properties. The hydroxyl group-containing (meth)acrylic copolymer may have a glass transition temperature of about-100° C. to about 10° C., for example, about −70° C. to about 0° C. Within this range, the adhesive film has good adhesion and reliability in a wide temperature range. The hydroxyl group-containing (meth)acrylic copolymer may have an index of refraction of about 1.35 to about 1.70, for example, about 1.40 to about 1.60. Within this range, the adhesive film may maintain transparency when stacked together with other optical films.

The monomer mixture may include an alkyl group-containing (meth)acrylate, a hydroxyl group-containing (meth)acrylate, and an alkylene glycol group-containing (meth)acrylate.

In one or more embodiments, the alkyl group-containing (meth)acrylate, the hydroxyl group-containing (meth)acrylate, and the alkylene glycol group-containing (meth)acrylate may be present in a total amount of about 95 wt % or more, for example, about 95 wt % to 100 wt %, or 100 wt %, in the monomer mixture, based on a total weight of 100 wt % of the monomer mixture.

Details of the alkyl group-containing (meth)acrylate may be substantially the same as those described in the composition for the first region.

The alkyl group-containing (meth)acrylate may be present in an amount of about 10 wt % to about 80 wt %, for example, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, or about 40 wt % to about 80 wt %, or about 50 wt % to about 60 wt %, in the monomer mixture, based on the total weight of the monomer mixture. Within this range, the adhesive film may achieve further improvement in adhesion and durability.

Details of the hydroxyl-containing (meth)acrylate may be substantially the same as those described in the composition for the first region.

The hydroxyl-containing (meth)acrylate may be present in an amount of about 10 wt % to about 40 wt %, for example, about 10 wt %, about 15 wt %, about 20 wt %, about 25 wt %, about 30 wt %, about 35 wt %, about 40 wt %, or about 10 wt % to about 30 wt %, or about 10 wt % to about 20 wt %, in the monomer mixture, based on the total weight of the monomer mixture. Within this range, the adhesive film may achieve further improvement in adhesion and durability.

The alkylene glycol group-containing (meth)acrylates may include a (meth)acrylic acid ester having an alkylene glycol group, for example, an ethylene glycol group or a propylene glycol group, at an ester site thereof. For example, the alkylene glycol group-containing (meth)acrylate may include at least one selected from among 2-ethylhexyl triethylene glycol (meth)acrylate, methoxy triethylene glycol (meth)acrylate, phenoxy triethylene glycol (meth)acrylate, phenoxy diethylene glycol (meth)acrylate, phenoxy polyethylene glycol (meth)acrylate, and phenoxy polyethylene glycol (meth)acrylate.

The alkylene glycol group-containing (meth)acrylate may be present in an amount of about 10 wt % to about 50 wt %, for example, about 10 wt %, about 15 wt %, about 20 wt %, about 25 wt %, about 30 wt %, about 35 wt %, about 40 wt %, about 45 wt %, about 50 wt %, or about 10 wt % to about 40 wt %, or about 20 wt % to about 30 wt %, in the monomer mixture, based on the total weight of the monomer mixture. Within this range, the adhesive film may achieve further improvement in adhesion and durability.

In one or more embodiments, the monomer mixture may further include a copolymerizable monomer in addition to the monomers mentioned above. The copolymerizable monomer may include at least one selected from among an amine group-containing monomer, an alkylene glycol group-containing monomer, a silane group-containing monomer, and an aromatic group-containing monomer.

Details of the initiator may be substantially the same as the initiator described in the compositions of the first region.

The initiator may be present in an amount of about 0.0001 parts by weight to about 5 parts by weight, for example, about 0.001 parts by weight to about 3 parts by weight, for example, about 0.001 parts by weight to about 1 part by weight, relative to 100 parts by weight of the monomer mixture. Within this range, the initiator may secure complete curing of the composition without deterioration in light transmittance of the adhesive film due to remaining initiator, and may exhibit good reactivity while suppressing generation of bubbles.

In one or more embodiments, the composition for the second region may further include at least one selected from among a crosslinking agent and additives.

The crosslinking agent and the additives may be substantially the same as those described above in the composition for the first region.

The crosslinking agent may be present in an amount of about 0.0001 parts by weight to about 5 parts by weight, for example, about 0.1 parts by weight to about 5 parts by weight, for example, about 0.5 parts by weight to about 1 part by weight, relative to 100 parts by weight of the monomer mixture.

The silane coupling agent may be present in an amount of about 0.0001 parts by weight to about 5 parts by weight, for example, about 0.1 parts by weight to about 5 parts by weight, for example, about 0.5 parts by weight to about 1 part by weight, relative to 100 parts by weight of the monomer mixture.

### Manufacture of Adhesive Film

The adhesive film may be manufactured by applying the composition for the first region and the composition for the second region to predetermined thicknesses on a release film to produce a coating for the first region and a coating for the second region, in which the coating for the first region contacts the coating for the second region. Next, the entirety of the first region coating and the second region coating may be prepared by light curing at a same intensity.

An optical display apparatus according to one or more embodiments of the present disclosure includes the adhesive film according to the present disclosure. The optical display apparatus may include an organic light emitting device display, a liquid crystal display, and/or the like. The optical display apparatus may include a flexible display apparatus. However, the optical display apparatus may also include a non-flexible display apparatus.

Next, the present disclosure will be described in more detail with reference to Examples. However, it should be understood that these examples are provided for illustration only and should not be construed in any way as limiting the disclosure.

### Example 1

### Preparation of Composition for First Region

In a reactor, 0.005 parts by weight of Irgacure 651 (2,2-dimethoxy-2-phenylacetophenone, BASF) as a photopolymerization initiator was sufficiently mixed with 100 parts by weight of a monomer mixture including 40 wt % of 2-ethylhexyl acrylate (2-EHA), 40 wt % of isobornyl acrylate (IBOA), 10 wt % of 4-hydroxybutyl acrylate (4-HBA), and 10 wt % of acryloylmorpholine (ACMO). After replacing dissolved oxygen in the reactor with nitrogen gas, the mixture was partially polymerized by irradiation with UV light using a low-pressure mercury lamp (BL Lamp, Sankyo) to obtain a solution containing an acrylic copolymer having a viscosity of about 1,000 cP.

To the solution containing the acrylic copolymer, 0.3 parts by weight of Irgacure 651 (2,2-dimethoxy-2-phenylacetophenone, BASF) as a photoinitiator, 1 part by weight of 1,6-hexanediol diacrylate as a crosslinking agent, and 0.2 parts by weight of 3-glycidoxypropyltriethoxysilane as a silane coupling agent relative to 100 parts by weight of the monomer mixture were added and mixed to prepare a composition for a first region.

### Preparation of Compositions for the Second Region

In a reactor, 0.005 parts by weight of Irgacure 651 (2,2-dimethoxy-2-phenylacetophenone, BASF) as a photopolymerization initiator was sufficiently mixed with 100 parts by weight of a monomer mixture including 60 wt % of 2-ethylhexyl acrylate (2-EHA), 20 wt % of 4-hydroxybutyl acrylate (4-HBA), and 20 wt % of methoxytriethyleneglycol acrylate (EHDG-AT), followed by replacing dissolved oxygen in the reactor with nitrogen gas in the same manner. Then, the mixture was partially polymerized by irradiation with UV light using a low-pressure mercury lamp (BL Lamp, Sankyo) to obtain a solution containing an acrylic copolymer having a viscosity of about 1,000 cP.

To the solution containing the acrylic copolymer, 0.3 parts by weight of Irgacure 651 (2,2-dimethoxy-2-phenylacetophenone, BASF) as a photoinitiator, 0.1 parts by weight of 1,6-hexanediol diacrylate as a crosslinking agent, and 0.2 parts by weight of 3-glycidoxypropyltriethoxysilane as a silane coupling agent relative to 100 parts by weight of the monomer mixture were added and mixed to prepare a composition for a second region.

A coating for the first region was prepared by depositing the composition for the first region to a predetermined thickness on a polyethylene terephthalate (PET) release film, and a coating for the second region was prepared by depositing the composition for the second region to the same thickness along the coating for the first region. The coating for the first region and the coating for the second region were formed to contact each other side by side.

An adhesive sheet of PET film-adhesive film (thickness: 25 μm) including PET film-adhesive film (thickness: 25 μm) including the first region and the second region-PET film was prepared by attaching a PET film to the entirety of the first region and the second region, followed by irradiating with UV light at a dose of 2,000 mJ/cm².

### Examples 2 to 4

Each of adhesive films was prepared in substantially the same manner as in Example 1 except that each component of the compositions for the first region and the second region was changed as listed in Table 1.

### Comparative Examples 1 to 5

Each of adhesive films was prepared in substantially the same manner as in Example 1 except that each component of the compositions for the first region and the second region was changed as listed in Table 1.

The adhesive layers prepared in Examples and Comparative Examples were each evaluated as to properties listed in Table 1 and results are shown in Table 1.

### (1) Storage Modulus (Unit: MPa):

A dynamic viscoelasticity measurement device (ARES, Anton Paar, MCR-501) was used to measure viscoelasticity for each of the first and second regions of the adhesive film under auto strain conditions at a shear rate of 1 rad/sec and a strain of 1%. After removing all of the PET release films from the adhesive sheet, specimens were prepared by stacking each of the first region or the second region to a thickness of 500 μm, followed by punching the resulting stack using a punching machine having a diameter of 8 mm. For each of the specimens, storage modulus was measured at 25° C. and at 60° C. under a condition of a temperature increase rate of 5° C./min from −60° C. to 90° C.

### (2) Impact Resistance:

After peeling off the release PET film from each of the adhesive sheets prepared in Examples and Comparative Examples, a polyurethane film (thickness: 100 μm, CPU (casting polyurethane) with a Young's modulus of 100 MPa at room temperature) was attached to the surface of the adhesive sheet, from which the release PET film was removed. After peeling off the remaining release PET film from the adhesive sheet, a PET film (thickness: 50 μm, TU-94, SKC) was attached to the adhesive sheet, which in turn was stacked on a glass substrate via with an acrylic adhesive sheet.

A pen having a diameter of 0.7 mm and a circular cross-section was dropped from a height vertically onto the first region of the specimen stacked in the following order: polyurethane film/adhesive film/PET film/acrylic adhesive sheet/glass substrate. After the polyurethane film and the adhesive film were removed, any indentation on the PET film was checked under a 3D microscope (VK-X1100, KIENS). A height at which indentation or stamping occurred first on the PET film was measured. A height of 13 cm or more was evaluated as ⊚, a height of 10 cm to less than 13 cm was evaluated as ◯, a height of 7 cm to less than 10 cm was evaluated as Δ, and a height of less than 7 cm was evaluated as X.

### (3) Rollability:

From each of the adhesive sheets prepared in Examples and Comparative

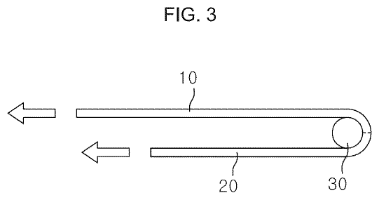

Examples, the release PET film was peeled off and a polyurethane film (thickness: 100 μm, CPU (casting polyurethane) with a Young's modulus of 100 MPa at room temperature) was attached to the surface of the adhesive sheet, from which the release PET film was removed. After peeling off the remaining release PET film from the adhesive sheet, a PET film (thickness: 50 μm, TU-94, SKC) was attached to the adhesive sheet, thereby preparing a specimen. Here, the polyurethane film was placed at the outermost side of the specimen. After a circular rod having a diameter of 3 mm was placed at the center of the second region of the adhesive film to become an axis, the rod was manually rolled to wind and unwind the specimen repeatedly by holding distal ends of the first and second regions. FIG. 3 illustrates a rollability evaluation method, in which an adhesive film including a portion 10 corresponding to the first region and a portion 20 corresponding to the second region was prepared, and the portion 10 and the portion 20 were pulled in the same direction, with a circular rod 30 placed between the portion 10 and the portion 20 of the adhesive film.

No cracking and/or delamination at the boundary between the second region and the first region of the adhesive film was evaluated as ∘ and cracking and/or delamination at the boundary therebetween was evaluated as X.

### (4) Creep (Unit: %):

A specimen having a thickness of 800 μm was prepared by stacking the first region of the adhesive film in multiple layers. Strain was measured on the prepared specimen at 60° C. under conditions of 1 N (force) and 600 sec using a DHR rheometer (TA Instruments).

TABLE 1

| | | | Example | | | | Comparative Example | | | | | |
|---|---|---|---|---|---|---|---|---|---|---|---|---|
| | | | 1 | 2 | 3 | 4 | 1 | 2 | 3 | 4 | 5 | 6 |
| First | Binder | 2-EHA | 40 | 40 | 45 | 30 | 52 | 54 | 42 | 59 | 42 | 44 |
| region | (wt %) | IBOA | 40 | 40 | 30 | 40 | 30 | 30 | 40 | 25 | 40 | 40 |
| | | 4-HBA | 10 | — | 20 | — | 15 | 15 | 10 | 10 | 5 | 5 |
| | | HEA | — | 10 | — | 20 | — | — | 5 | 5 | 10 | 10 |
| | | ACMO | 10 | 10 | — | — | 3 | 1 | — | — | — | — |
| | | NVP | — | — | 5 | 10 | — | — | 3 | 1 | 3 | 1 |
| | Photoinitiator | | 0.3 | 0.3 | 0.3 | 0.3 | 0.3 | 0.3 | 0.3 | 0.3 | 0.3 | 0.3 |
| | Crosslinking | | 1 | 0.5 | 0.5 | 1 | 1 | 0.5 | 1 | 0.5 | 1 | 0.5 |
| | agent | | | | | | | | | | | |
| | Silane | | 0.2 | 0.2 | 0.2 | 0.2 | 0.2 | 0.2 | 0.2 | 0.2 | 0.2 | 0.2 |
| | coupling agent | | | | | | | | | | | |
| | Impact | | ⊚ | ⊚ | ◯ | ⊚ | X | X | Δ | X | Δ | X |
| | resistance | | | | | | | | | | | |
| | Creep | @60° C. | 30 | 20 | 40 | 10 | 20 | 40 | 20 | 30 | 20 | 30 |
| | (%) | | | | | | | | | | | |
| | Modulus | @25° C. | 0.2 | 0.5 | 0.15 | 0.7 | 0.05 | 0.03 | 0.08 | 0.04 | 0.1 | 0.04 |
| | (MPa) | @60° C. | 0.07 | 0.08 | 0.05 | 0.1 | 0.02 | 0.01 | 0.02 | 0.03 | 0.03 | 0.015 |
| Second | Binder | 2-EHA | 60 | 60 | 60 | 60 | 70 | 80 | 80 | 80 | 70 | 80 |
| region | (wt %) | 4-HBA | 20 | 10 | 20 | 10 | 15 | 10 | 10 | 10 | 15 | 10 |
| | | EHDG-AT | 20 | 30 | 20 | 30 | 15 | 10 | 10 | 10 | 15 | 10 |
| | Photoinitiator | | 0.3 | 0.3 | 0.3 | 0.3 | 0.3 | 0.3 | 0.3 | 0.3 | 0.3 | 0.3 |
| | Crosslinking | | 0.1 | 0.1 | 0.1 | 0.1 | 0.2 | 0.1 | 0.1 | 0.1 | 0.2 | 0.1 |
| | agent | | | | | | | | | | | |
| | Silane | | 0.2 | 0.2 | 0.2 | 0.2 | 0.2 | 0.2 | 0.2 | 0.2 | 0.2 | 0.2 |
| | coupling agent | | | | | | | | | | | |
| | Modulus | @25° C. | 0.028 | 0.024 | 0.028 | 0.024 | 0.04 | 0.03 | 0.03 | 0.03 | 0.04 | 0.03 |
| | (MPa) | @60° C. | 0.02 | 0.019 | 0.022 | 0.015 | 0.02 | 0.01 | 0.01 | 0.01 | 0.02 | 0.01 |

| | | | | | | | | | | |
|---|---|---|---|---|---|---|---|---|---|---|
| Rollable | ◯ | ◯ | ◯ | ◯ | X | X | X | X | X | X |
| reliability | | | | | | | | | | |

| | | | | | | | | | | |
|---|---|---|---|---|---|---|---|---|---|---|
| Relation 1 | 0.140 | 0.048 | 0.187 | 0.034 | 0.8 | 1 | 0.375 | 0.75 | 0.267 | 0.75 |
| Relation 2 | 0.286 | 0.238 | 0.440 | 0.150 | 1 | 1 | 0.5 | 0.33 | 0.667 | 0.667 |

*HEA: 2-hydroxyethyl acrylate
*NVP: N-vinylpyrrolidone

As shown in Table 1, each of the adhesive films of Examples had good rollability and impact resistance.

However, the adhesive films of Comparative Examples not satisfying Relations 1 and 2 failed to achieve advantageous effects of the present disclosure.

In the present disclosure, it will be understood that the term “comprise(s)/comprising,” “include(s)/including,” or “has (have)/having” specifies the presence of stated features, numbers, steps, operations, elements, and/or components, but do not preclude the presence or addition of one or more other features, numbers, steps, operations, elements, components, and/or groups thereof. Additionally, the terms “comprise(s)/comprising,” “include(s)/including,” “has (have)/having,” or other similar terms include or support the terms “consisting of” and “consisting essentially of,” indicating the presence of stated features, numbers, steps, operations, elements, and/or components, without or essentially without the presence of other features, numbers, steps, operations, elements, components, and/or groups thereof.

As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure”.

In the present disclosure, expressions such as “at least one of,” “one of,” and “selected from,” when preceding a list of elements, modify the entire list of elements and do not modify the individual elements of the list. For example, “at least one of a, b or c”, “at least one selected from among a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in the present disclosure is intended to include all higher numerical limitations subsumed therein. Accordingly, Applicant reserves the right to amend the disclosure, including the claims, to expressly recite any sub-range subsumed within the ranges expressly recited herein.

In the context of the present disclosure and unless otherwise defined, the terms “use,” “using,” and “used” may be considered synonymous with the terms “utilize,” “utilizing,” and “utilized,” respectively.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims and equivalents thereof.

What is claimed is:

1. An adhesive film, comprising a first region and a second region having different storage moduli,
wherein the first region and the second region satisfy Relation 1 and Relation 2:
$$0.01 \leq {G}^{′} ( {25}^{∘} C . / B ) / {G}^{′} ( {25}^{∘} C . / A ) \leq 0 \text{.2} , \qquad ( Relation 1 )$$
where G′(25° C./A) denotes a storage modulus of the first region at 25° C. and G′(25° C./B) denotes a storage modulus of the second region at 25° C.; and
$$0.1 \leq {G}^{′} ( {60}^{∘} C . / B ) / {G}^{′} ( {60}^{∘} C . / A ) \leq 0 \text{.5} , \qquad ( Relation 2 )$$
where G′(60° C./A) denotes a storage modulus of the first region at 60° C. and G′(60° C./B) denotes a storage modulus of the second region at 60° C.

2. The adhesive film as claimed in claim 1, wherein the first region and the second region are laterally integrally formed with each other.

3. The adhesive film as claimed in claim 1, wherein the first region has a storage modulus of about 0.01 MPa to about 10 MPa at 25° C. and a storage modulus of about 0.005 MPa to about 1 MPa at 60° C.

4. The adhesive film as claimed in claim 1, wherein the first region has a creep of about 10% or more at 60° C.

5. The adhesive film as claimed in claim 1, wherein the second region has a storage modulus of about 0.001 MPa to about 1 MPa at 25° C. and a storage modulus of about 0.0005 MPa to about 0.1 MPa at 60° C.

6. The adhesive film as claimed in claim 1, wherein the first region comprises a photo-cured product of a composition for the first region, the composition comprising a monomer mixture and an initiator.

7. The adhesive film as claimed in claim 6, wherein the monomer mixture comprises an alkyl group-containing (meth)acrylate, an alicyclic group-containing (meth)acrylate, a hydroxyl group-containing (meth)acrylate, and a heterocyclic group-containing vinyl or (meth)acrylic monomer.

8. The adhesive film as claimed in claim 7, wherein the monomer mixture comprises about 10 wt % to about 80 wt % of the alkyl group-containing (meth)acrylate, about 10 wt % to about 60 wt % of the alicyclic group-containing (meth)acrylate, about 5 wt % to about 40 wt % of the hydroxyl group-containing (meth)acrylate, and about 1 wt % to 30 about wt % of the heterocyclic group-containing vinyl or (meth)acrylic monomer, based on a total weight of 100 wt % of the monomer mixture.

9. The adhesive film as claimed in claim 6, wherein the composition for the first region further comprises at least one selected from among a crosslinking agent and a silane coupling agent.

10. The adhesive film as claimed in claim 1, wherein the second region comprises a photo-cured product of a composition for the second region, the composition comprising a monomer mixture and an initiator.

11. The adhesive film as claimed in claim 10, wherein the monomer mixture comprises an alkyl group-containing (meth)acrylate, a hydroxyl group-containing (meth)acrylate, and an alkylene glycol group-containing (meth)acrylate.

12. The adhesive film as claimed in claim 11, wherein the monomer mixture comprises about 10 wt % to about 80 wt % of the alkyl group-containing (meth)acrylate, about 10 wt % to about 40 wt % of the hydroxyl group-containing (meth)acrylate, and about 10 wt % to about 50 wt % of the alkylene glycol group-containing (meth)acrylate, based on a total weight of 100 wt % of the monomer mixture.

13. The adhesive film as claimed in claim 10, wherein the composition for the second region further comprises at least one selected from among a crosslinking agent and a silane coupling agent.

14. The adhesive film as claimed in claim 1, wherein the adhesive film consists of two regions in total in the order of the first region and the second region on an outermost surface of the adhesive film in a longitudinal direction thereof, and
one of outermost surfaces of the adhesive film in a transverse direction constitutes the first region and the other outermost surface of the adhesive film in the transverse direction constitutes the second region.

15. An optical display apparatus comprising the adhesive film as claimed in claim 1.
